(19) United States
(12) Patent Application Publication
(10) Pub. No.: US 2007/0195307 A1
(43) Pub. Date: Aug. 23, 2007

(54) Projection lens and method for performing microlithography

(75) Inventors: Karl-Heinz Schuster, Koenigsbronn (DE); Eric Eva, Aalen (DE)

Correspondence Address: WOOD, PHILLIPS, KATZ, CLARK & MORTIMER, 500 W. MADISON STREET, SUITE 3800, CHICAGO, IL, 60661, US

(73) Assignee: CARL ZEISS SMT AG.

(21) Appl. No.: 11/644,406

(22) Filed: Dec. 21, 2006

Related U.S. Application Data
(60) Provisional application No. 60/754,109, filed on Dec. 27, 2005.

(51) Int. Cl. G03B 27/32

(52) U.S. Cl. 355/77; 359/717

(57) ABSTRACT

A projection lens for microlithography is provided comprising transparent optical elements not having direct contact and being spaced apart at most half of the wavelength the lens is designed for by a separator. Thus the corresponding gap is optically almost equivalent to a direct contact.

### CROSS-REFERENCE TO RELATED APPLICATION

This application claims the benefit of pending U.S. provisional patent application Ser. No. 60/754,109, filed Dec. 27, 2005. Its disclosure is considered part of and is incorporated by reference in the disclosure of this application.

### TECHNICAL FIELD

The present invention relates to a projection lens for microlithography. Further, it relates to a method for producing such projection lenses. Moreover, the invention also relates to a method for performing microlithography with such a projection lens. Furthermore, it relates to a corresponding microlithography system employing such a projection lens.

### BACKGROUND ART

One of the main aspects in the development of projection lenses for microlithography is that the structures to be built on a substrate become smaller and smaller. Small structures yield a high density of (e.g. electronic) components which has positive effects on the capability of the structures, e.g. of an integrated circuit, and on the production efficiency.

The size of the components on the substrate depends on the resolution of the microlithographic projection system in general and particularly on the resolution of the projection lens. High resolution projection lenses do often comprise lenses of very high thickness for refracting the projection light.

Since the resolution is reciprocal to the wavelength of the projection light, an approach is to reduce the wavelength of the projection light. Usually, a wavelength corresponding to deep ultra-violet light is chosen, e.g. 193 nm or 157 nm.

Additionally, as another approach an immersion liquid can be employed between the last lens of the projection system in front of the substrate and the substrate, e.g. a wafer. Projection lenses which are used together with an immersion liquid have relatively high numerical apertures—compared to a “dry” set up.

### SUMMARY OF THE INVENTION

It is an object of the invention to provide improved projection lenses for microlithography adapted for deep ultra-violet lithography.

Further, it is an object of the invention to provide a corresponding method for producing improved projection lenses for microlithography.

Further, it is an object of the invention to provide a method for performing deep ultra-violet microlithography with an improved projection lens.

Moreover, it is an object of the invention to provide a corresponding step-and-scan system for microlithography which employs such an improved projection lens.

The invention is defined in the appended claims. The following disclosure is to be understood as relating to the projection lens, the system for microlithography and the method aspects of the invention as well.

The basic idea of the invention is to combine transparent optical elements to a single optical unit while avoiding direct contact which can cause problems.

If the transparent optical elements were in direct contact, a relative movement, e.g. as a result of warming and different thermal expansion coefficients, would cause the optical surfaces to detach, move locally and reattach. This would result in local stress birefringence and possibly also mechanical damage to the surfaces of the transparent optical elements.

Of course, a transparent optical element has to be transparent for the operating wavelength of interest. Such an optical element can be e.g. a lens or simply a transparent sheet of material covering or separating specific parts of the projection lens. Usually a transparent optical element which is suited for shaping the bundle of light rays is called a lens.

The transparent optical elements are arranged to face each other, but they are not in direct contact. This results in a gap between the adjacent transparent optical elements. During operation, the light passes through the gap from the first transparent optical element into the second transparent optical element, and finally the light will leave the projection lens for performing microlithography on a substrate. Passing through the gap, the light occupies a cross-sectional area within the gap. This area can differ for different operating conditions. The corresponding superposition of cross-sectional areas is called the optically clear aperture. To avoid occlusion of the light passing through the optically clear aperture, the gap is laterally larger than the optically clear aperture.

A separator prevents the transparent optical elements from direct contact. Possible implementations for such a separator are presented below.

If the gap between adjacent optical elements is thin enough, this gap is optically almost equivalent to a direct contact. The gap should have a width of at most half of the wavelength the lens is designed for. A width of at most a tenth of that wavelength is more preferred. A width of at most the twentieth, fiftieth or the hundredth part of that wavelength is even more preferred. Some examples of appropriate wavelength are: 248 nm, 193 nm, 157 nm and 126 nm. The gap can be evacuated or filled with a fluid.

In a preferred embodiment, the gap between the facing sides of the adjacent optical elements is homogeneously spaced. This is preferred independently of a special geometry of the gap, since employing a homogeneously spaced gap facilitates optical homogeneity. A preferred realisation displays adjacent optical elements which are flat and parallel within the optically clear aperture. Such a geometry is particularly easy to manufacture. Another preferred realisation displays adjacent optical elements which are curved—with a given radius of curvature—within the optically clear aperture. Other geometries might be chosen, e.g. also aspherical ones, depending on the optical requirements.

As a separator, a material, e.g. gold, which is interposed between the adjacent optical elements and which surrounds the optically clear aperture can be employed. The material can display the shape of a ring, i.e. a continuous, roundish closed shape. However, also discontinuous designs can be a worthwhile solution, inter alia a number of patches of material. The main requirements are that the spacer material be essentially uniform in thickness and that it does not occupy the optically clear aperture diameters of either optical surface. In addition, the material can also serve as a lubricant. The material can be organic or inorganic. It can comprise a metallic component. Possible choices could be: gold, PTFE, chrome and nickel. PTFE is especially appropriate to serve as a lubricant. Depending on the material, the ring could be produced by vapor deposition or chemical deposition. The production method of choice might be applied to any type of transparent optical elements.

Masks as well as resists may be employed to obtain the desired lateral distribution of the spacer material. After deposition, it may be necessary to structure the material in order to obtain a uniform thickness or to change the lateral distribution. Any of the following techniques may be used to this aim: polishing, local polishing, grinding, laser ablation, ion beam figuring and etching. Again, contactless or contacting masks or resists may be used to assist ablation, figuring or etching.

To connect the adjacent optical elements, a clip can be attached to them mutually connecting the optical elements. Such a clip can surround a significant part of and can be attached to the rim of each of the transparent optical elements. The pressure mutually applied by such a clip should be sufficient to secure the optical elements but it should not cause them to bend.

In order to improve a transmission of the interface between adjacent optical elements, preferably at least two transparent layers interposed between them can be added. However, these layers do not completely fill the gap between the facing elements. Each layer can have a refractive index smaller than the adjacent material. Transmission losses are reduced.

Separating the transparent optical elements can be accomplished by employing nanoparticles as a separator. Here a particle is considered a nanoparticle if it is small enough to fit into the gap between adjacent optical elements of the projection lens. It is still considered a nanoparticle if it fits into the gap by deforming the particle (or the facing sides of the two elements). However, to be considered a nanoparticle the particle should be larger than the atomic or molecular constituents of the optical elements or a material that is used for coating these elements. In addition, it should be sufficient to define a separation between the optical elements. These nanoparticles are dispersed between adjacent optical elements, separating them and allowing some relative movement by rolling or sliding. In this sense the nanoparticles serve as a lubricant.

Especially flat nanoparticles facilitate sliding. Many nanoparticles are at least a little bit ductile and are thus flattened by the pressure executed by the adjacent optical elements. The pressure on the nanoparticles might be increased during manufacturing of the projection lens, e.g. by momentarily pressing adjacent optical elements together. Flattening of the nanoparticles can be facilitated by lateral movement or rotation of the adjacent optical elements. In case of non-ductile nanoparticles, an interesting option is to choose nanoparticles with a narrow width distribution. The width distribution of the nanoparticles—measured across the gap—can allow for a homogeneously spaced gap. This might also imply deformations of transparent optical elements. Nanoparticles display a preferred narrow width distribution, if more than 66% of all nanoparticles display a width between a lower value and an upper value exhibiting a ratio of 3:1, 2:1 or even 1.5:1. These ratios are increasingly preferred in the given order. Even more preferred is, if more than 90% of all nanoparticles display a width within the intervals given above (increasingly preferred in the given order).

The density of the nanoparticles is supposed to be low, i.e. most nanoparticles are spatially isolated from other nanoparticles. There should not be any coherent patches of nanoparticles.

To avoid outgassing of the nanoparticles out of the gap they should adhere to one of the surfaces of the adjacent optical elements or to both of them. Since usually ultra-violet light is employed for microlithography, the nanoparticles should be resistant against it.

Of special interest for using nanoparticles as an implementation of the separator are fullerenes, especially fullerenes which are substantially spherical. “Substantially” since there is not a perfectly spherical fullerene. Not even the famous “Bucky Ball” (B60) is strictly spherical. Another class of fullerenes that might be employed as a cover element separator are column-shaped fullerenes, such as “nanotubes”.

A different class of material, that can be employed as a separator is zeolite. Of special interest, also independent of the above-mentioned shapes, is a mixture of zeolite A and gmelinit I. Zeolite A is substantially cubish and gmelinit I is substantially round. Zeolite A can stabilise the width of the gap and gmelinit I can work as a lubricant.

Employing transparent optical elements, in particular lenses, that carry a non-rotationally symmetric aspherization on at least one surface, allows for higher order image corrections. If the lens element is rotatable, image aberrations can be manipulated and corrected in situ.

In a preferred embodiment the gap between the adjacent optical elements is filled with a fluid. Even more preferred is a liquid filling. This liquid displays a refractive index which does not deviate by more than 30% from the refractive index of the adjacent optical elements. Even more preferred is a deviation which does not exceed 20% or even 10%. Depending on the refractive index of the adjacent optical elements, suitable liquids can comprise so-called ‘high-index liquids’, as they are used as immersion liquids. Examples for such a liquid are cyclohexane (n≠1,57 at 193 nm) or dekalin (n≠1,65 at 193 nm). Preferably the liquid is water or a liquid hydrocarbon. Corresponding liquid hydrocarbons, in addition to the equally preferred above-mentioned, can be Hexane or Cyclooctane.

A further preferred embodiment of the invention is to provide a transparent cover element for the projection lens which covers the rest of the lens from an immersion liquid. Especially covering the last lens element, i.e. the last lens before the wafer, is of interest. Employing the wording of claim 1, now the first transparent optical element corresponds to the last lens element and the second transparent optical element corresponds to the cover element. Without cover, this last lens element would be immersed in the immersion liquid during operation. This could result in a contamination of the last lens element, e.g. by detached photo resist floating in the immersion liquid, or it might even result in a degradation of the last lens element due to physical and chemical processes involving the last lens element and the immersion liquid. Adjusting the last lens element is usually a critical step and requires elaborate procedures. Replacing a (contaminated) cover element is a worthwhile alternative.

Since the cover element and the last lens element correspond to adjacent transparent optical elements, they are separated by a corresponding gap as described above.

As a cover element separator preventing direct contact of the last lens element and the cover element, a separator as described above can be employed. Further aspects of implementing a cover element separator are described below.

Since the gap between the last lens element and the cover element is thin enough, the gap is optically almost equivalent to a direct contact. Thus, there is no reduction of the numerical aperture due to this gap. It is preferred to evacuate the gap between the last lens element and the cover element or to fill it with air or another gas.

Using non-polar, i.e. organic, substances as an immersion liquid, typically implicates the problem that the immersion liquid might not be resistant to the ultra-violet light which is employed for microlithography. Thus, it is preferred to adapt the invention for the use of a polar immersion liquid, e.g. demonised water. Consequently, for the cover element a material which is resistant to the employed polar liquid is chosen.

Often the last lens element is chosen to consist of a salt crystal, e.g. calcium fluoride. Calcium fluoride does not exhibit light-induced compaction unlike other materials, usually vitreous, that are usually used for building lenses. Such salt crystals are partially soluble in polar liquids, such as deionised water. Using water that is saturated with the ions the crystal consists of will stop the net mass loss of the crystal, but the surface of the lens will still rearrange, resulting in increasing roughness and hence light scatter over time. As a consequence, a cover element adapted for the use with a polar liquid is highly desirable. The cover element can consist of fused silica, which is transparent for ultra-violet light and resistant to polar liquids.

To connect the last lens element and the cover element, a clip can be attached to them. As above, the clip can surround a significant part of and can be attached to the rim of the cover element and it can be attached to a corresponding significant part of the rim of the last lens element. The pressure applied by such clip should be sufficient to secure the last lens element but it should not cause it to bend.

Instead of attaching the clip holding the cover element to the last lens element, it can be attached to a mounting which is connected to a supporting structure of the projection lens. For attaching the clip, the cover element should provide for some stability. The cover element can be thicker than 1 mm. More preferred is minimal thickness of 3 mm.

The rim of the cover element can extend beyond the rim of the last lens element. E.g. the cover element can comprise extensions, which are oriented such that they are turned away from the substrate, enveloping the side of the last lens element which faces the substrate. These extensions can make up a continuous wall. Thus, the cover element resembles a bucket. Such a bucket-like shape can allow operation with a gap positioned below the surface of the immersion liquid and still prevent the intrusion of immersion liquid into the gap. Furthermore, such extensions can be attached to a mounting, e.g. by a clip. Such extensions can for example be built by vapor deposition or chemical deposition onto the cover element.

High energy densities might damage a fused silica cover element, depending inter alia on the quality of the fused silica. For very thin cover elements this problem is less severe than for thicker ones. One preferred embodiment can comprise a fused silica cover element, which is thinner than 10 mm. More preferred is a maximal thickness of 5 mm, 1 mm, 500 μm or 200 μm. These values are increasingly preferred in the given order. However, the cover element can be thicker than 10 μm to provide for some mechanical stability. More preferred is a minimal thickness of 50 μm or even 100 μm. For manufacturing a very thin cover element one can polish a slice of fused silica on one of its faces, add a cover element separator, e.g. nanoparticles (see above), to this face, bring it in its position close to the last lens element, laterally fixate the cover element and polish the other face of the fused silica cover element.

E.g. the cover element can be fixated within a fitting and the last lens element can be arranged on top of the cover element, so that the last lens element is basically held in position by gravitation. In case of sudden mechanical shocks only very small amounts of air might enter or leave the gap between the last lens element and the cover element at once. Thus the last lens element sticks to the cover element. In addition, van der Waals forces might further improve fixation, in case that sudden mechanical shocks occur during transportation, for example.

Since most of the presented separators allow for lateral movement of the cover element with respect to the last lens element a lateral support for the cover element is advantageous. For some of the presented separators, e.g. the ones which are based on nanoparticles, a vertical support of the cover element is advantageous as well.

Due to the possibility of such a lateral movement, it is advantageous to provide a driving element, e.g. a piezo element, which is built to move the last lens element relative to the cover element. Thus, lateral corrections can be performed.

Instead of keeping the last lens element and the cover element apart passively, their distance can be adjusted actively. A driving element, e.g. a piezo element, can be attached to the cover element, an extension of the cover element or a mounting supporting the cover element. While being directly or indirectly connected to the last lens element, such a driving element can actively adjust the separation between the last lens element and the cover element. This might be necessary in case of adjustment insufficiencies or changes of the lens geometry due to size changes of its components, e.g. as they occur due to a temperature change. Using a driving element might tighten the need for mechanical stability. In such a case, the cover element can be thicker than 1 mm. More preferred is a minimal thickness of 3 mm.

To detect the actual distance between the last lens element and the cover element a capacitive or inductive detection set up can be employed. Its electronic components can be embedded in or on the facing elements. E.g. in case of a capacitive set up, thin metallic patches can be embedded locally within the surfaces of the facing elements. If properly aligned they work as a capacitor. A change in the distance between the charged metallic patches results in a change in the voltage between them, which is easy to detect. Calibration can involve mutual contact at zero distance.

As mentioned above, lens elements that carry a non-rotationally symmetric aspherization on at least one surface allow for higher order image corrections. If such a lens element is rotatable, image correction can be manipulated and corrected in situ. In such a case it is advantageous to provide a driving element, which is built to rotate the last lens element relative to the cover element. The driving element might rotate the last lens element via a (cog)wheel, piezo elements, ultrasound ora rotating electromagnetic field. For coupling the rotating electromagnetic field to the last lens element, one can attach ferromagnetic material to the last lens element.

A further preferred embodiment of the invention is to assemble the projection lens from separate lens elements. In the wording of claim 1 these lens elements now correspond to the transparent optical elements. This allows to manufacture an optical element of high thickness by combining comparatively thin elements. Manufacturing optical elements of high thickness can be especially difficult. E.g. if a thick optical element is produced by sintering and pressing, it is very challenging to find appropriate processing conditions as heating and cooling schedules to achieve sufficiently homogeneous optical properties.

As described for transparent optical elements in general, the separate lens elements are adjacently arranged and face each other while not being in direct contact. As a consequence, there is also a gap between adjacent lens elements.

It is difficult to combine separate lens elements to one thicker lens by bringing them into direct contact, since this requires an extremely accurate adjustment of the contacting surfaces. E.g. wringing together lens elements which do not fit perfectly to each other might result e.g. in stress birefringence. These problems are avoided as outlined below.

To prevent the lens elements from direct contact, a lens separator is provided. Possible implementations for such a lens separator correspond to the implementation for the separator described above.

A sufficiently thin gap between adjacent lens elements is—as explained above—optically almost equivalent to a direct contact. The gap between adjacent separate lens elements can be evacuated or filled with a fluid.

It is preferred to employ lens elements which are made of CaF₂, MgAl₂O₄ or garnet, in particular Lu₃Al₅O₁₂. Corresponding lens elements can be made of a single crystal of one of these materials or be polycrystalline (see also below).

To protect the projection lens comprising separate lens elements from an immersion liquid, it is preferred to provide a cover element as described above for the projection lens. In this preferred embodiment, one of the separate lens elements corresponds to the last lens element. Thus, the surface of the last lens element facing the substrate is protected from an immersion liquid by the cover element, wherein the last lens element and the cover element are separated by a gap adjusted by the cover element separator. Furthermore, the opposing surface of the last lens element is separated from an adjacent lens element by a gap adjusted by the lens separator. Both gaps are optically almost equivalent to a direct contact.

Depending on the material the lens elements are made of, they can display intrinsic birefringence. This applies especially to single crystal materials which are commonly used for optical elements adapted for the use with ultraviolet light. E.g. the last lens element of a projection lens for microlithography is typically made of a single crystal of CaF₂ which displays intrinsic birefringence. A further difficulty with the use of single crystal material for optical elements is the production of the so-called blanks, since the growth of single crystals is a highly elaborate process. The single crystal blanks generally have a cylindrical shape. When manufacturing optical elements for a projection lens whose geometry often differs to a major extent from the cylindrical shape of the blanks, it is therefore generally necessary to remove a considerable amount of material. In addition to the loss of material associated with this, manufacturing the optical elements from the blanks can be difficult, depending on the material characteristics, such as the hardness or the cleavability of the crystals used.

As a consequence, it is preferred to use a polycrystalline material for the lens elements of the projection lens. In polycrystalline material individual monocrystalline units, also referred to as crystallites or grains, are arranged with crystal axes oriented more or less randomly in space. Thus, the mean value of intrinsic birefringence in all spatial directions is essentially zero. It has turned out that it is beneficial to choose a polycrystalline material with a mean crystallite size in the range from 0.5 μm to 100 μm, better from 10 μm to 100 μm, more preferred in the range from 10 μm to 50 μm, and even more preferred in the range from 20 μm to 30 μm; in particular, a mean crystallite size of approximately 25 μm is preferred.

A polycrystalline blank for optical applications can be produced from high-purity powder raw material by sintering a blend followed by pressing. In this way, it is possible to produce a blank which already at this stage has virtually the same geometry as the optical element to be manufactured from it. The amount of material that has to be removed for final processing is correspondingly relatively small.

It is preferred to choose a polycrystalline material with a crystallite size distribution such that for a wavelength of less than 250 nm, in particular less than 193 nm, birefringence is less than 1 nm/cm, in particular less than 0.5 nm/cm. It is preferred to employ garnet, in particular Lu₃Al₅O₁₂, or MgAl₂O₄ as polycrystalline materials.

In another preferred embodiment, intrinsically birefringent lens elements of the projection lens are arranged in a way to reduce the cumulative negative influence of the intrinsically birefringent lens elements. Along an optical axis of the projection lens intersecting the clear aperture, the first lens element and the second lens element are consecutively arranged. To compensate for the changes in polarisation due to the single lens elements, both lens elements display the same crystal plane orthogonal to the optical axis and they are mutually twisted around the optical axis (‘clocking’).

It is especially preferred to provide the projection lens with four lens elements made of a crystalline intrinsically birefringent material being arranged consecutively along the optical axis. Two pairs of these four lens elements display an identical crystal plane within the pair orthogonal to the optical axis. The lens elements of each pair are mutually twisted around the optical axis relative to the other lens element of the same pair. Further, the four lens elements of the two pairs are alternately arranged with respect to the pairs. This arrangement is especially suited to compensate for the effects of the intrinsic birefringence of the single lens elements, since the order of the lens elements is not arbitrary with respect to the cumulative change in polarisation.

This fact can be expressed in terms of so-called Jones matrices which are suitable for describing lenses with intrinsic birefringence. These matrices do not commutate, i.e. the order of the lens elements can have an influence on the cumulative change of polarisation due to all single lens elements.

According to another preferred embodiment, at least one of the lens elements is made of a crystalline intrinsically birefringent material, wherein this lens element displays a crystal orientation parallel to the optical axis differing from the [100], [110], [111] orientation and equivalent crystal orientations. Due to this ‘free’ crystal orientation additional degrees of freedom are introduced, facilitating optimisation of the system. In addition to that, the phase of the (1, 1)-Jones-pupil is reduced. As a consequence, also further requirements with respect to the optical mapping might be accomplished in a better way.

A further aspect of the invention relates to a method for producing a projection lens as it is described above. Fundamental steps for a preferred embodiment of the production method are: acquiring the topography of the last lens element at its side which is intended to point towards a substrate, e.g. a wafer, and assigning the inverse of said topography to said cover element at its side which is intended to point toward the last lens element.

The topography can be acquired by interferometry. To take the effects of gravitation on the shape of the last lens element into account, acquiring the topography of the surface of the last lens element can be performed in the post assembly orientation. For the same reason, not only the measurement can be performed in the post assembly orientation, but also forming the surface of the cover element. Forming the surface of the cover element can be done by ion beam figuring (IBF). To further facilitate an accurate shaping, the measurement of the topography of the last lens element can be performed in its fitting. For the same reason the cover element can be exposed in its fitting to the ion beam.

For flat surfaces polishing can suffice to yield the projected quality. Polishing is, compared to IBF, less elaborate.

Hereunder, preferred embodiments of the invention will be described in more detail. These embodiments are merely illustrative and not meant to limit the scope of the invention as defined in the claims. The features disclosed could also be relevant in other combination.

### BRIEF DESCRIPTION OF THE DRAWINGS

FIG. 1 shows a schematic cross-sectional view of a last lens element and a cover element as a part of a first embodiment.

FIG. 2 shows a schematic cross-sectional view of a last lens element and a cover element as a part of a second embodiment.

FIG. 3 shows a schematic cross-sectional view of a last lens element and a cover element as a part of a third embodiment.

FIG. 4 shows a schematic cross-sectional view of a last lens element and a cover element as in FIG. 1, wherein the cover element is immersed in a liquid and is separated from the last lens element by a cover element separator, adding more details to the first embodiment.

FIGS. 5 a, b show a schematic top view of two variations of the cover element of FIG. 4.

FIG. 6 shows a schematic cross-sectional view of a last lens element and a cover element, held together by a clip as part of a fourth embodiment.

FIG. 7 shows a schematic cross-sectional view of a last lens element and a cover element supported by a mounting as part of a fifth embodiment.

FIG. 8 shows a 90 degree rotated schematic cross-sectional view of FIG. 7.

FIG. 9 shows a schematic cross-sectional view of a last lens element and a cover element, which corresponds to a combination of the embodiments of FIGS. 6 and 8 as part of another embodiment.

FIG. 10 a shows a variation of FIG. 9 as part of a seventh embodiment of the invention.

FIG. 10 b shows a detail of FIG. 10 a.

FIG. 11 shows a schematic cross-sectional view of a last lens element and a cover element, wherein the facing sides of the elements are coated as part of an eighth embodiment.

FIG. 12 shows a schematic cross-sectional view of a last lens element, a cover element and a cover element separator as part of another embodiment.

FIG. 13 shows means for giving lateral and vertical support to the cover element as part of a tenth embodiment.

FIG. 14 shows a schematic diagram of an ion beam figuring process.

FIG. 15 shows a schematic cross-sectional view of four lens elements belonging to a projection lens as another embodiment.

FIG. 16 shows a schematic cross-sectional view of four lens elements plus a cover element belonging to a projection lens as a twelfth embodiment.

FIG. 17 shows a schematic cross-sectional view of two facing surfaces of two adjacent lens elements as a thirteenth embodiment.

FIG. 18 shows a schematic cross-sectional view of four lens elements supported by a clip as another embodiment.

### DETAILED DESCRIPTION OF THE PREFERRED EMBODIMENTS

The following embodiments refer to the field of projection lenses for microlithography.

FIGS. 1 to 3 show a variety of geometries which are suitable as an embodiment. These figures show a last lens element 1-3, a cover element 30-32 and a gap 12-14 between the last lens element 1-3 and the cover element 30-32. Note, that the last lens element 1-3 and the cover element 30-32 do not have direct contact. The elements 1-3, 30-32 are aligned such that they face each other. Further, the lateral extension of the gap 12-14 between the elements 1-3, 30-32 is at least as large as the optically clear aperture (see FIGS. 5a, 12a). The gap 12-14 is thin compared to the operating wavelength the elements 1-3, 30-32 are designed for. Here the wavelength is chosen to be 193 nm. The gap 12-14 has a width of 1.5 nm and is filled with air. In this case, the gap 12-14 is so thin, that it is optically almost equivalent to a direct contact.

Furthermore, the gap 12-14 is homogeneously spaced. Tolerances with respect to this homogeneity due to production insufficiencies are discussed further below.

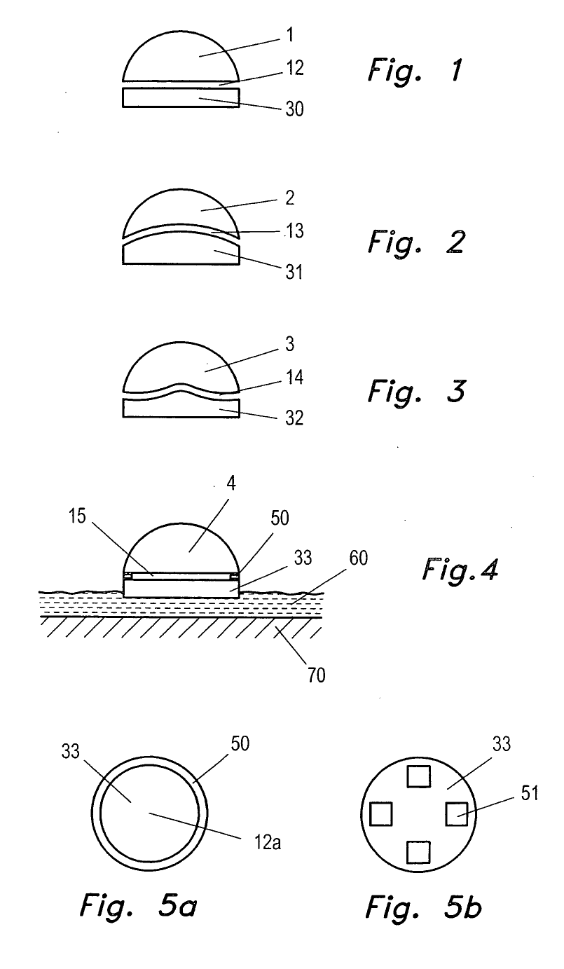

In FIG. 1 the facing surfaces of the elements 1, 30 are flat and in FIG. 2 they (2, 31) are spherical with a given radius of curvature. The curvature of the last lens element 2 is matching the curvature of the cover element 31. FIG. 3 gives a schematic example of an aspherical last lens element 32 together with a matching aspherical cover element 32. The features of the drawing are strongly exaggerated for clarity and only symbolic.

In FIG. 4, a last lens element 4 is separated from a cover element 33 by a cover element separator 50. The last lens element 4 and the cover element 33 correspond to the last lens element 1 and the cover element 30 of FIG. 1. As a material for the last lens element 4, calcium fluoride is chosen, for the cover element 33, fused silica is chosen. The cover element separator 50 is a ring of material, here gold, which is applied to the cover element 33 by vapour deposition, e.g. evaporation, and which keeps the elements 4, 33 spaced apart, here by 1.5 nm. The ring 50 is running along the circumference of the elements 4, 33. Its center is void, i.e. it is filled with air, so it does not occlude the optically clear aperture during operation. An immersion liquid 60 covers a wafer 70, wherein the immersion liquid 60 is deionised water. The cover element 33 is partly immersed in the immersion liquid 60.

FIG. 5a shows a top view of the cover element 33. The ring 50 is continuously spread along the circumference of the cover element 33. Its center is void. Since the ring 50 is continuous, it can also serve a barrier, protecting the gap 15 from the immersion liquid 60. An area 12a within the gap corresponds to the optically clear aperture 12a of the projection lens, i.e. the maximum cross-sectional area within the gap meant to let the light pass through. Note that the area bordered by the ring 50 is laterally larger than the optically clear aperture 12a.

FIG. 5b shows a variation of FIG. 5 a. Here the cover element separator 51 is not a closed ring but simply consists of some patches of gold, surrounding an inner void area. Since the gold cover element separator 50 in FIGS. 4 and 5 does not only serve as a cover element separator, but also as a lubricant, the last lens element 4 and the cover element 33 can slide relative to each other, e.g. due to different thermal expansion behaviour.

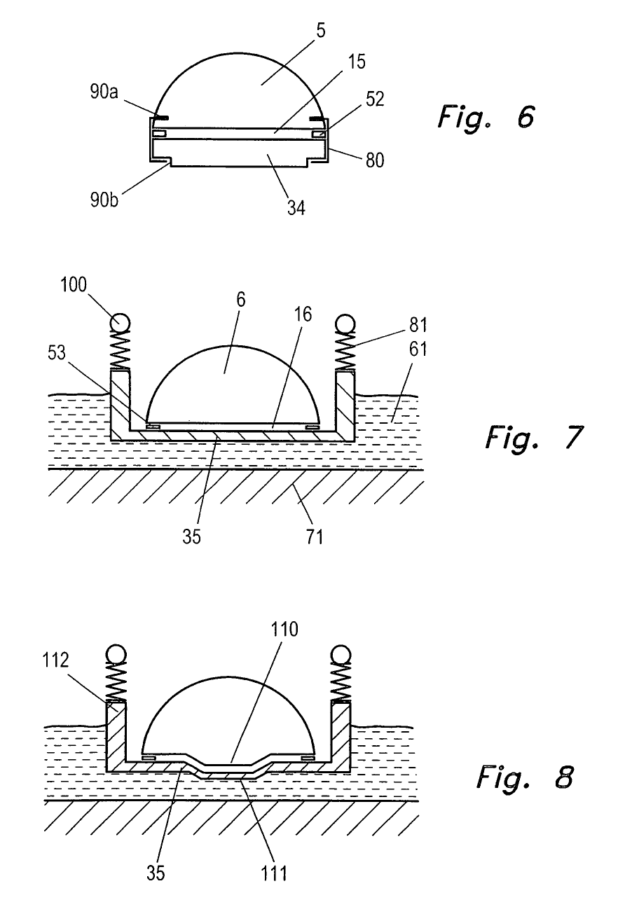

A last lens element 5 and a cover element 34 are shown in FIG. 6. They correspond basically to the elements 4, 33 in FIG. 4. As in FIG. 4 their facing surfaces are flat and the gap is homogeneously spaced, displaying a width of 1.5 nm. They are kept apart by a ring 52 of gold (which corresponds to the cover element separator 50 in FIG. 4). A clip 80 is attached to the cover element 34 and the last lens element 5, pressing the elements 5 and 34 together. The clip 80 surrounds the elements 5, 34 and is attached to recesses 90a, 90b, which are fitting cut-outs in the last lens element 5 and the cover element 34. The cover element 34 is made of fused silica and is 4 mm thick. The strength of the clip 80 is adjusted to keep the elements 5, 34 together, however, the cover element 34 is not bent. Here the clip 80 might also serve as an additional barrier, further protecting the gap 15 from the immersion liquid.

In FIG. 7, the last lens element 6, the cover element separator 53, the immersion liquid 61, the gap 16 and the substrate 71 correspond to their equivalents in FIG. 4. A cover element 35 is bucket-like shaped, i.e. it has continuous walls which surround the last lens element 6. The last lens element 6 resides within this cover element 35. Note, that the surface of the immersion liquid 61 is above the level of the gap 16. Due to the bucket-like shape of the cover element 35, an intrusion of the immersion liquid 61 into the gap 16 is avoided. The cover element 35 is attached to a mounting 100 by clips 81, which is symbolized by circles. The mounting 100 is connected to supporting means within the projection lens.

FIG. 8 presents a 90 degree rotated schematic cross-sectional view of the embodiment shown in FIG. 7. The reference numerals refer to the same elements as in FIG. 7. Here it can be seen, that the last lens element 6 comprises a projection 110 at its side facing the cover element 35. The area of the projection 110 corresponds to the optically clear aperture. The cover element 35 displays a corresponding indentation 111 of 4 mm width. The sections 112 of the cover element 35, which are not situated within the optically clear aperture are thicker, here 10 mm. As a consequence, the cover element 35 is relatively stiff.

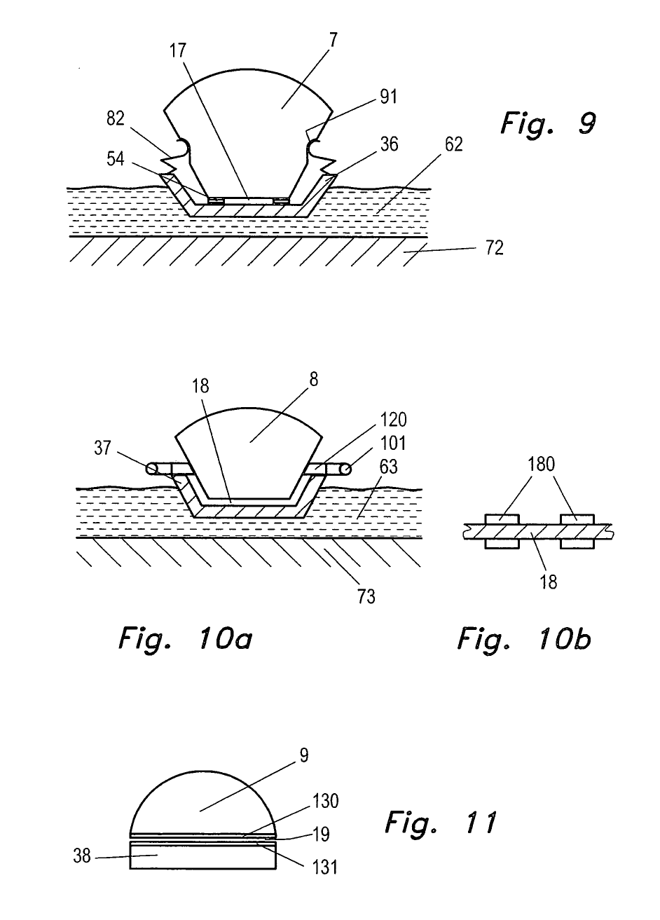

FIG. 9 shows a combination of the embodiments of FIGS. 6 and 7 and it basically shows the same elements as FIG. 7. A last lens element 7 is connected to a cover element 36 by several clips 82. The last lens element 7 displays recesses 91 for attaching the clips 82. As in FIG. 7 the cover element 36 has a bucket-like shape und helps preventing the intrusion of the immersion liquid 62 into the gap 17.

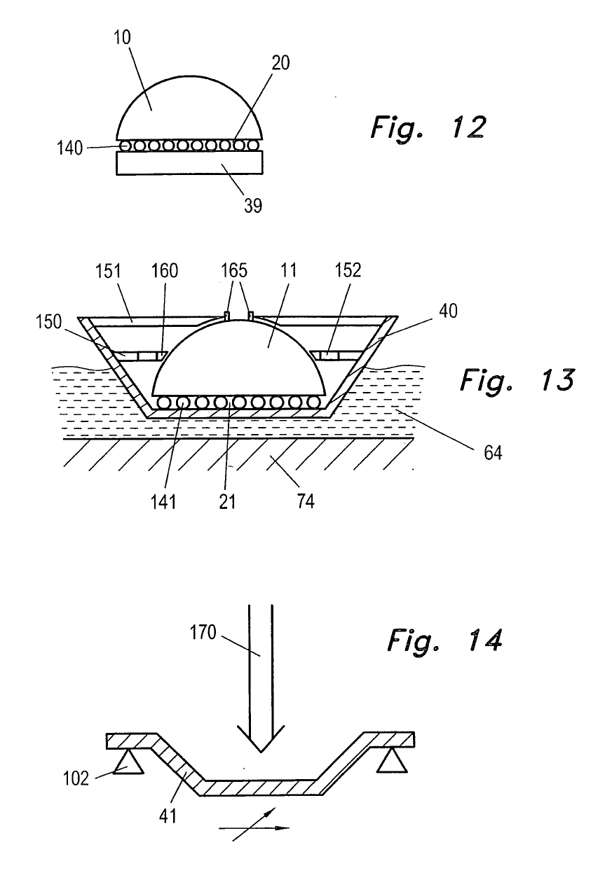

FIG. 10a shows an active implementation for separating a last lens element 8 (calcium fluoride) and a cover element 37 (fused silica). As in FIG. 8, the immersion liquid 63 is water and the substrate 73 is a wafer. In this embodiment there is no material passively separating the elements 8 and 37. The gap 18 has the properties described within the context of FIG. 1. The cover element 37 is bucket-shaped, has a width of 4 mm and its walls extend above the surface of the immersion liquid 63. At its top are four piezo driving elements 120, only two of them being shown and the remaining two being situated in a cross-like arrangement before and behind the plane of the figure. The last lens element 8 is supported on these driving elements and has slanted faces. For adjusting the width of gap 18, the piezo elements 120 can expand or contract. As a consequence, the last lens element 8 is moving up or down. The piezo elements 120 are connected to a mounting 101, which is attached to a support structure of the projection lens (not shown).

FIG. 10b shows a detail of FIG. 10a. For adjusting the proper width of the gap 18, an electronic height detection system 180 is employed. Thin metal patches 180 are embedded within the surfaces of the last lens element 8 and the cover element 37. They are aligned to be situated in front of each other. Each patch is connected with a thin wire (not drawn) to an electronic control device (not drawn). This control device can charge the metal patches and measure the voltage between opposing patches. As in a standard capacitor the voltage depends on the separation between the electrodes (patches) which can be calculated.

The last lens element 9 and the cover element 38 in FIG. 11 are equivalent to the elements 1 and 30 in FIG. 1. Also the gap 19 has the same properties as the gap 12 in FIG. 1. In addition to the embodiment in FIG. 1, respective layers 130 and 131 of chiolite are deposited on the facing sides of the last lens element 9 and the cover element 38. These layers 130, 131 serve as an intermediate step in the refractive index. Thus, any transmission losses are further reduced.

In FIG. 12 one can see a last lens element 10 as in FIG. 4. The gap 20 has basically the same properties as the gap 12 in FIG. 1. A cover element 39 consists of fused silica and has, as a difference to FIG. 4, a width of 150 μm. As a cover element separator 140, nanoparticles are employed. In this embodiment these nanoparticles 140 are nanotubes. The nanotubes 140 keep the last lens element and the cover element apart and define the width of the gap 20. Note, that the nanotubes 140 are dispersed within the gap 20 with a low density, such that most nanotubes are mutually spaced. 95% of the nanotubes have a diameter between 1.2 and 1.5 nm. They do also function as a lubricant or, in otherwords, as interposed sliding means.

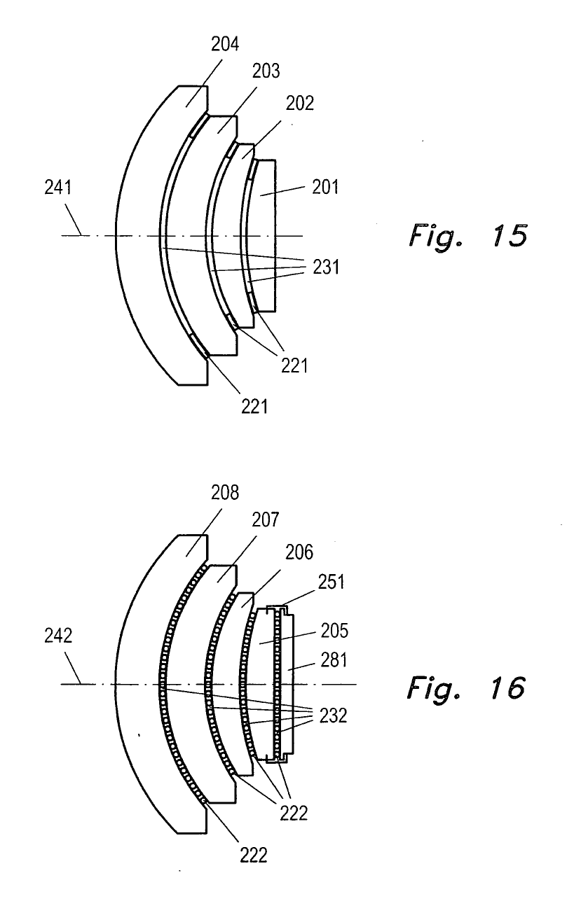

FIG. 13 shows a last lens element 11, consisting of calcium fluoride, a fused silica cover element 40 and a gap 21, which has the same properties as the gap 12 in FIG. 1. The cover element 40 is bucket-shaped and is immersed in deionised water as an immersion liquid 64 covering a wafer 74. Spherical nanoparticles 141, e.g. B 60, define the width of the gap 21. Four lateral support bars 150 (also consisting of fused silica) are extended from the walls of the cover element 40 towards the last lens element 11. These four lateral support bars 150 are arranged in a cross like arrangement. Only two of them can be seen, since the other two are situated outside of the plane of the drawing. At their respective ends, they support an elastic rubber buffer 160 and a piezo element 152 for laterally shifting the last lens element relative to the cover element. Since the nanoparticles 141 serve as a lubricant, the cover element 40 can move relative to the last lens element 11 due to material expansions/contractions during operation. The lateral support bars 150 confine these movements.

Four vertical support bars 151 (also consisting of fused silica) are projecting from the cover element 40 towards the last lens element 11. Also the vertical support bars 151 are arranged in a cross-like arrangement.

On top of the last lens element two small magnets 165 are arranged, such that a rotating electromagnetic field can couple to these magnets and thus rotate the last lens element.

A schematic diagram of the ion beam figuring process (IBF) is shown in FIG. 14. A bucket-shaped fused silica cover element 41 is held by a mounting 102, which is connected to a supporting structure within the IBF-machine (not shown). An ion beam 170 precisely removes layers of material. As a consequence, the intended shape is produced. The cover element 41 is mounted in its post assembly orientation to take the effect of gravitation into account. Furthermore, it is mounted in its fitting (not shown) as it will be arranged in a completed projection lens.

When assembled, the deviation from homogeneity of the surface measured between opposing points of the last lens element and the cover element 41 within the optically clear aperture is less than 0.3 nm. The largest deviation from homogeneity measured across the facing sides of the last lens element and the cover element 41—not only opposing points—is below 0.4 nm, i.e. the cumulative depth of the one deepest dent from each of the two surfaces.

For flat surfaces polishing might suffice to yield the projected quality. Polishing is, compared to IBF, less elaborate.

FIG. 15 shows four lens elements 201-204 being arranged consecutively along an optical axis 241 facing each other. The four lens elements 201-204 are not in direct contact but are separated by gaps 231. The width of the gaps 231 is adjusted by lens separators 221.

The four lens elements 201-204 are made of calcium fluoride and belong to a projection lens for microlithography which is designed to operate with light of a wavelength of 193 nm. The lens separators 221 are rings of a material, i.e. gold, which is applied to the lens elements 201-204 by vapour deposition and which keeps the lens elements 201-204 apart, here by 1.5 nm. The lens separating rings 221 are running along the circumference of the lens elements 201-204. The centre of the ring-shaped lens separators 221 is void. Thus the optical axis 241 intersects the optically clear apertures which are not occluded by the lens separators 221. A view along the optical axis 241 on top of e.g. lens element 203 would, in a schematic figure, basically look the same as the cover element 33 or the cover element separator 50 in FIG. 5a. Thus, a corresponding view of one of the lens elements 201-204 is not shown. The facing sides of adjacent lens elements 201-204 are homogeneously spaced along their spherical surface. The gaps 231 are evacuated, wherein the lens separators 221 prevent influx of surrounding air.

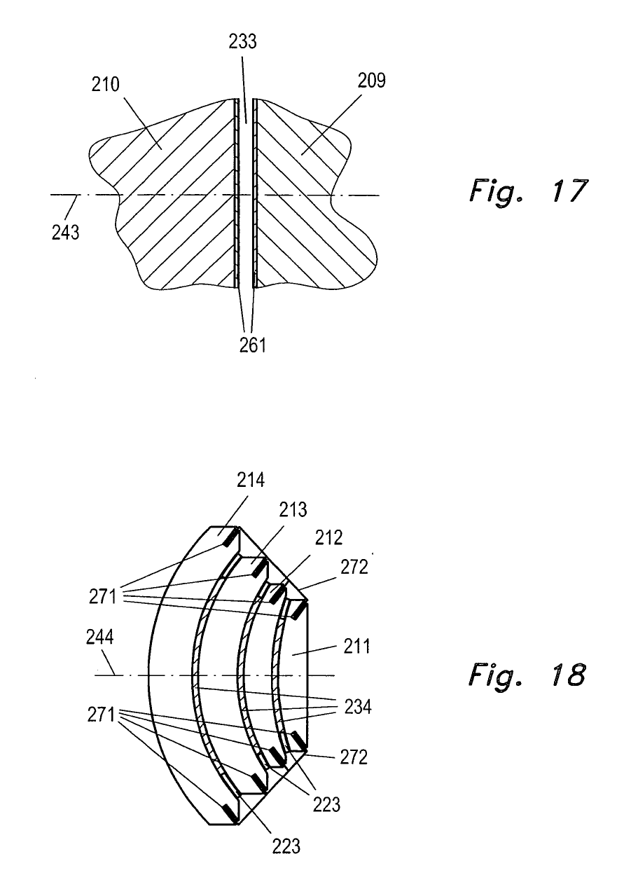

FIG. 16 shows a similar arrangement as FIG. 15. Lens elements 205-208 are arranged basically in the same way as in FIG. 15. Different from FIG. 15, the lens elements 205-208 are made of Lu₃A1₅O₁₂ or MgAl₂O₄ as an alternative. The material of the lens elements 205-208 comprises many crystallites with a mean width of approximately 25 μm. As a consequence the lens elements 205-208 display a birefringence of only 0.4 nm/cm. Arranged within a projection lens, the lens element 205 corresponds to the last lens element. To protect it from an immersion liquid and debris floating within the immersion liquid, it is covered with a cover element 281 made of fused silica. The cover element 281 displays a width of 4 mm and is attached to lens element 205 by a clip 251, as in FIG. 6. The cover element 281 is separated from lens element 205 by nanotubes displaying the same properties as described in the context of FIG. 12. The lens elements 205-208 are separated via gaps 232 by nanotubes 222 as well. The nanotubes 222 serving as lens separators between the lens elements 205 to 208 do have the same properties as the nanotubes separating the cover element 281 from the last lens element 205.

As a first alternative to nanotubes, zeolites can be used for separating lens elements 205-208 and cover elements 281 from the last lens element 205 respectively. A second alternative is to employ B60. Lens element 208 is rotationally asymmetric and aspheric (not shown) to provide means for a higher order image correction.

FIG. 17 shows a section of two adjacent lens elements 209 and 210 displaying a gap 233 separating the lens elements 209 and 210 from each other. As the separator, a metallic ring surrounding the optically clear aperture is employed as in FIG. 15. Different from FIG. 15, the facing sides of the lens elements 209 and 210 are flat within the optically clear aperture. Layers 261 of chiolite are deposited on the facing sides of the two adjacent lens elements 209 and 210. These layers 261 serve as an intermediate step in the refractive index for reducing transmission losses, as mentioned in the context of FIG. 11. The lens elements 209 and 210 are each made of crystalline calcium fluoride, which is intrinsically birefringent. Lens elements 209 and 210 are consecutively arranged along an optical axis 243 of the projection lens. Lens element 210 displays a [100] orientation parallel to the optical axis 243, whereas the lens element 209 displays a ‘free’ orientation.

FIG. 18 shows four lens elements 211-214 each made of crystalline calcium fluoride. The lens elements 211-214 are separated by lens separators 223 as in FIG. 15 resulting in gaps as in FIG. 15. Different from the arrangement in FIG. 15 the gaps 234 are filled with cyclohexane. Another difference is that each lens element 211-214 provides a recess 271 along the full length of its circumference. Within the recesses 271 clips 272 are inserted to attach the lens elements 211-214 to each other. As in FIG. 15, an optical axis 244 is intersecting an optically clear aperture of the arrangement. The lens elements 212 and 214 display an identical crystal plane orthogonal to optical axis 244 and are mutually twisted around the optical axis 244. The same applies for the lens elements 211 and 213, however, these two lens elements display a different crystal plane than the lens elements 212 and 214.

1. A projection lens for microlithography which is designed for an operating wavelength comprising
a first transparent optical element,
a second transparent optical element and
a separator,
wherein said first optical element and said second optical element
do not have direct contact,
are arranged to face each other such that the resulting gap is laterally larger than an optically clear aperture and
are spaced apart by said separator at most half of said operating wavelength, at least within said optically clear aperture.

2. The lens of claim 1 in which said first optical element and said second optical element are spaced apart by said separator at most a tenth of said operating wavelength, at least within said optically clear aperture.

3. The lens of claim 1 which is designed for ultra violet light, e.g. comprising a wavelength of 193 nm.

4. The lens of claim 1 in which the facing sides of said first optical element and said second optical element are homogeneously spaced within said optically clear aperture.

5. The lens of claim 4 in which the facing sides of said first optical element and said second optical element are flat within said optically clear aperture.

6. The lens of claim 4 in which the facing sides of said first optical element and said second optical element both display a radius of curvature within said optically clear aperture.

7. The lens of claim 1 in which said separator comprises a solid material, which
is interposed between said first optical element and said second optical element,
and surrounds said optically clear aperture.

8. (canceled)

9. (canceled)

10. The lens of claim 1 comprising at least one transparent layer interposed between said first optical element and said second optical element.

11. The lens of claim 1 in which said separator comprises nanoparticles defining the distance between said first optical element and said second optical element.

12. The lens of claim 11 in which more than 66% of said nanoparticles display a width between a lower value and an upper value exhibiting a ratio of 3:1.

13. The lens of claim 11 in which said nanoparticles are one of fullerenes and zeolites and are one of substantially spherical and column shaped, e.g. nanotubes.

14. The lens of claim 1 in which said first optical element is rotationally asymmetric.

15. The lens of claim 1 in which said gap comprises a fluid.

16. The lens of claim 15 in which said fluid is one of water and a liquid hydrocarbon.

17. The lens of claim 1 in which said first optical element is a last lens element, said second optical element is a cover element for covering said last lens element from an immersion liquid during operation and said separator is a cover element separator.

18. The lens of claim 17 in which the projection lens is adapted for the use of a polar liquid, e.g. water, as an immersion liquid.

19. The lens of claim 17 in which said last lens element comprises a salt crystal, e.g. calcium fluoride.

20. The lens of claim 17 in which said cover element consists of fused silica.

21. (canceled)

22. (canceled)

23. The lens of claim 17 comprising at least one driving element, e.g. a piezo element, for moving said last lens element relative to said cover element.

24. The lens of claim 23 wherein said cover element separator comprises at least one driving element, e.g. a piezo element, for vertically adjusting the width of said gap.

25. The lens of claim 23 in which said driving element is capable of rotating said last lens element relative to said cover element.

26. The lens of claim 1 in which said first optical element is a first lens element, said second optical element is a second lens element and said separator is a lens separator.

27. The lens of claim 26 in which one of said first lens element and said second lens element comprises one of CaF₂, spinel and garnet.

28. The lens of claim 26 comprising also a cover element separator and a cover element, wherein said first lens element is said last lens element of said projection lens and said last lens element and said cover element
do not have direct contact,
are arranged to face each other such that the resulting gap is laterally larger than an optically clear aperture and
are spaced apart by said cover element separator at most half of said ope
rating wavelength, at least within said optically clear aperture.

29. The lens of claim 26 in which one of said first lens element and said second lens element comprises a polycrystalline material.

30. The lens of claim 26 comprising an optical axis intersecting said clear aperture in which said first lens element and said second lens element are arranged consecutively along said optical axis and are made of a crystalline intrinsically birefringent material, wherein
said first lens element and said second lens element display the same crystal plane orthogonal to said optical axis and are mutually twisted around said optical axis.

31. The lens of claim 30 comprising at least four lens elements being arranged consecutively along said optical axis and are made of a crystalline intrinsically birefringent material, wherein
two pairs of said four lens elements display an identical crystal plane orthogonal to said optical axis within said pair wherein said lens elements of each pair are mutually twisted around said optical axis relative to the other lens element of the same pair, and wherein
said four lens elements of said two pairs are alternately arranged with respect to said pairs.

32. The lens of claim 26 in which said first lens element and said second lens element are arranged consecutively along said optical axis and are made of a crystalline intrinsically birefringent material, wherein
at least for one of said first and said second lens elements said optical axis is parallel to a crystal orientation of said at least one lens element differing from the [100], [110], [111] orientation and equivalent crystal orientations.

33. (canceled)

34. (canceled)

35. (canceled)

36. (canceled)

37. (canceled)

38. (canceled)

39. (canceled)

40. (canceled)

41. (canceled)

42. (canceled)
